(19) United States
(12) Patent Application Publication
(10) Pub. No.: US 2014/0278118 A1
(43) Pub. Date: Sep. 18, 2014

(54) SYSTEM AND METHOD FOR ATTENUATING NOISE IN SEISMIC DATA

(71) Applicants: Sandra Tegtmeier-Last, San Ramon, CA (US); Bogdan Lukasz Kustowski, Walnut Creek, CA (US); Douglas William Clark, San Ramon, CA (US); Gilles Hennenfent, San Ramon, CA (US); Harry Martin, Red Bank, NJ (US)

(72) Inventors: Sandra Tegtmeier-Last, San Ramon, CA (US); Bogdan Lukasz Kustowski, Walnut Creek, CA (US); Douglas William Clark, San Ramon, CA (US); Gilles Hennenfent, San Ramon, CA (US); Harry Martin, Red Bank, NJ (US)

(73) Assignee: Chevron U.S.A. Inc., San Ramon, CA (US)

(21) Appl. No.: 13/803,944

(22) Filed: Mar. 14, 2013

(51) Int. Cl. G01V 1/36

(52) U.S. Cl. CPC G01V 1/364
USPC 702/17

(57) ABSTRACT

A system and method for attenuating noise in seismic data representative of a subsurface region of interest including receiving a seismic dataset representative of seismic signal or seismic noise and a seismic dataset representative of seismic signal and noise, transforming them into a domain were they have sparse or compressible representation, comparing the sets of coefficients to identify desirable coefficients in the set of coefficients representing the signal and noise dataset, selecting the desirable coefficients to produce an improved set of coefficients, and inverse transforming the improved set of coefficients to produce a modified seismic dataset. The modified seismic dataset may be noise-attenuated seismic data or may be a noise model that is subtracted from the original data to produce noise-attenuated data.

### FIELD OF THE INVENTION

The present invention relates generally to methods and systems for processing seismic data and, in particular, methods and systems for attenuating noise in seismic data.

### BACKGROUND OF THE INVENTION

Exploration for and development of hydrocarbon reservoirs may be efficiently done with the help of seismic data, which must be properly processed in order to allow interpretation of subsurface features. Generally, seismic data is acquired by using active seismic sources to inject seismic energy into the subsurface which is then refracted or reflected by subsurface features and recorded at seismic receivers. In practice, seismic data is often contaminated by noise which may be coherent or incoherent (e.g. random) in nature.

Efficient and effective methods for attenuating noise in seismic data are needed to improve the final seismic image and allow proper interpretation of the subsurface features.

### SUMMARY OF THE INVENTION

Described herein are implementations of various approaches for a computer-implemented method for noise attenuation in seismic data.

A computer-implemented method for attenuating noise in seismic data representative of a subsurface region of interest is disclosed. The method includes receiving a first seismic dataset representative of seismic signal and seismic noise and a second seismic dataset representative of seismic signal or noise, transforming the seismic datasets into a domain where they have sparse or compressible representation, comparing the sets of transformed coefficients to identify desirable coefficients in the transformed signal and noise dataset, selecting the desirable coefficients of the transformed signal and noise dataset to get a set of improved coefficients, and inverse transforming the set of improved coefficients to get a modified seismic dataset. The modified seismic dataset may be representative of the signal or the noise, depending on which coefficients were selected. If the modified seismic dataset is representative of the noise, it can be subtracted from the original signal and noise dataset to produce a dataset representative of the signal.

In another embodiment, a computer system including a data source or storage device, at least one computer processor and a user interface used to implement the method for attenuating noise in the seismic data is disclosed.

In yet another embodiment, an article of manufacture including a computer readable medium having computer readable code on it, the computer readable code being configured to implement a method for attenuating noise in seismic data representative of a subsurface region of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 illustrates a step in an embodiment of the present invention;

FIG. 3 shows an application of an embodiment of the present invention attenuating random noise;

FIG. 4A shows an application of one embodiment of the present invention attenuating a multiple reflection;

FIG. 4B shows an application of one embodiment of the present invention;

FIG. 5 shows an application of another embodiment of the present invention attenuating random noise without damaging signal;

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices. The present invention may also be practiced as part of a down-hole sensor or measuring device or as part of a laboratory measuring device.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to attenuating noise in seismic data. One embodiment of the present invention is shown as method 100 in FIG. 1. At operation 12, two seismic datasets are received. One of these datasets is representative of the seismic signal and noise, for example the vertical component of motion recorded at geophones of the ocean-bottom sensors, and may be considered the first seismic dataset. The other dataset is representative of only the seismic signal, for example hydrophone recordings taken by ocean-bottom sensors, and may be considered the second seismic dataset. These examples are not meant to be limiting; any instance in which at least two seismic datasets are available wherein at least one dataset is believed to be largely free of noise or free of signal in comparison to the other dataset may be used as input for this method. Moreover, the input datasets may be arranged and/or preprocessed in a variety of ways, including, by way of example and not limitation multiple time-lapse datasets, stacks or partial stacks of seismic data, a noise or signal model that is generated based on expected behaviors of the seismic waves, such as multiple reflections, or based on known behavior of a seismic processing algorithm. The datasets may be shot gathers, common receiver gathers, common offset gathers, offset vector tiles, common image gathers (angle or offset), and may be arranged in different directions such as inline, crossline, or depth/time slices; combinations of these may also be used. One skilled in the art will appreciate that other arrangements and preprocessing of the datasets are possible and can also be used as input for operation 12. Additionally, the seismic datasets may be recordings using active sources such as airguns or passive sources. The recordings may be made, for example, by towed streamers, ocean bottom cables, ocean bottom nodes, or land-based sensors such as geophones or accelerometers in any number of receiver array configurations including, for example, 2-D line surveys, 3-D surveys, wide-azimuth and full-azimuth surveys. Active sources may be fired simultaneously or sequentially, in linear source geometries or in alternative geometries such as coil shooting. Combinations of different source or receiver types may be used. The datasets may be time-lapse data, such as a baseline and monitor survey. Additionally, one or more of the seismic datasets may be synthetic data. One skilled in the art will appreciate that there are many ways to generate synthetic seismic data suitable for the first and/or second seismic datasets.

In an embodiment, there may be more than two input datasets. One input dataset will be representative of signal and noise and is the same as the first seismic dataset previously described. The other datasets may be representative of different models of just the signal or just the noise. In this embodiment, the additional signal or noise models would be treated in the same manner as the second seismic dataset, as previously described, throughout the method.

At operation 13 of method 100, the first and second seismic datasets are transformed into a domain in which they have a sparse or compressible representation. The transformation may be done using a multi-scale, multi-directional transform. The transformation may be performed on a 2-D section such as an inline or crossline section or a time or depth slice, or on a 3-D volume of data. The datasets may be transformed into a curvelet domain or a wavelet domain. These examples are not meant to be limiting; any domain in which the transformed data has a sparse or compressible representation may be used in this method. Additionally, one skilled in the art will appreciate that it is also possible to transform a 1-D trace into a domain in which the transformed data has a sparse or compressible representation.

At operation 14, the representative coefficients of the transformed first and second datasets are compared with each other. Representative coefficients of the first, signal-and-noise seismic dataset that are close to representative coefficients of the second, signal dataset can be considered to represent the signal in the second seismic dataset. Representative coefficients of the first seismic dataset that are close to those of the second seismic dataset are considered desirable.

A process for performing operation 14 is shown in FIG. 2. Here, the first seismic dataset (signal+noise) has been transformed into the curvelet domain and its coefficients are represented on graph 14A. Two other input datasets representative of the signal have also been transformed and are represented as signal model 1 at graph 14B and signal model 2 at 14C. Graphs 14B and 14C show the signal model coefficients in bold dashed lines overlain on corresponding coefficients from the signal+noise data shown as thin solid lines. Graphs 14B and 14C indicate a defined threshold for each signal model coefficient with the dashed horizontal lines. The defined threshold may be some default threshold (e.g. ±10%), be based on the distribution of coefficient sizes between the signal models, or be user-specified. The signal+noise coefficients are indicated on graph 14D as thin lines. Where the coefficients fall within the ranges based on the signal models, these coefficients are found to be desirable while the other coefficients are judged undesirable, indicated in graph 14D with a bold X. Each signal+noise coefficient is compared to the corresponding coefficients of each signal model. A user may choose to accept only the coefficients that are sufficiently close to all of the signal models or may choose to accept coefficients that are sufficiently close to at least one signal model. One skilled in the art will appreciate that it is also possible to perform this step using one or more noise models rather than signal models; either signal or noise models are within the scope of the present invention.

At operation 15, the desirable coefficients of the first seismic dataset are selected. This may be done by setting the undesirable coefficients to zero, which has the effect of removing the coefficients related to the noise from the first seismic dataset. Other methods for selecting the desirable coefficients are possible including, by way of example and not limitation, modifying the undesirable coefficients in a way so as to make them different from the desirable coefficients or modifying the desirable coefficients. The modification of the desirable coefficients may be done to differentiate them from the undesirable coefficients or to emphasize particular attributes of the desirable coefficients. In an embodiment, the desirable representative coefficients of the first seismic dataset are those related to the signal. It is also possible to split the coefficients of the first seismic dataset into two sets of coefficients, the desirable and the undesirable, and pass both sets to the next operation so that the undesirable part of the first seismic dataset can be observed.

The desirable coefficients of the first seismic dataset are inverse transformed at operation 16 to create a noise-attenuated first seismic dataset. If the undesirable coefficients were split into a separate set rather than being zeroed, operation 16 can also separately transform the undesirable coefficients.

One skilled in the art will also appreciate that at operation 14, it is also possible to change the designation of undesirable coefficients to be those that are close to the representative coefficients of the second seismic dataset. This has the effect of calling the signal in the first seismic dataset undesirable, so the signal is removed by the zeroing at operation 15 and the inverse transform of operation 16 will produce a noise model.

FIG. 3 illustrates the result of an embodiment of the method 100 of FIG. 1 that performs noise attenuation. Here, the second input seismic dataset representative of signal is shown as the signal gather 22. The first input seismic dataset representative of the signal and noise is shown as signal+noise gather 24. Note that the polarity of the primary event 23 is reversed compared to primary event 25. This is intended to mimic hydrophone data and synthetic vertical-component geophone data from an ocean-bottom node (OBN).

The noise-attenuated seismic gather 26 is the result of an embodiment of method 100. The primary event 27 is clearly signal and the noise has been largely attenuated. In this instance, since the primary events 23 and 25 had opposite polarities, it was necessary to take the absolute value of the representative coefficients of the first and second seismic datasets. One skilled in the art will appreciate that there are a number of modifications that may be made to the input datasets or to the representative coefficients in the sparse or compressible domain to ensure that the coefficients are comparable.

FIG. 4A shows an example of an embodiment of the present invention that performs multiple suppression. Panel 32 shows a seismic gather with a primary arrival 31 and a multiple arrival 33. The primary arrival 31 may be considered the signal and the multiple arrival 33 may be considered noise. In this embodiment, the desirable coefficients of operation 15 in FIG. 1 are those representative of the multiple arrival (noise). The result of method 100 is the noise model seen in panel 34 with the multiple arrival 35. This noise model may be subtracted from the input gather to get the noise-attenuated signal shown in panel 36 as primary arrival 37. Alternatively, during operation 15 the desirable coefficients may be selected to be representative of the signal (primary arrival 31) which would mean the output of method 100 would be noise-attenuated data like panel 36.

FIG. 4B shows an example of an embodiment of the present invention for ocean-bottom node data. The vertical geophone gather 44 is contaminated by so-called Vz noise. The hydrophone gather 42 is considered to be a signal model since it does not contain, or contains very little, Vz noise. After performing method 100, the noise-attenuated vertical geophone gather 48 is obtained, as is the noise model 46. Note that after attenuating the strong Vz noise in oval 49 of vertical geophone gather 44, it is possible to see signal in oval 49 on the noise-attenuated vertical geophone gather 48.

FIG. 5 shows an example of another embodiment of the present invention that performs noise removal with a signal de-bias. Panel 52 shows the signal+noise input dataset which includes the events 51 and 53, and random noise. Panel 54 is the noise model with signal bias, meaning that some part of the signal 53 has been included in the noise model although it has a much lower amplitude than the same event in panel 52. Panel 56 is the output from method 100, showing noise-attenuated data. Note that in this example, the random noise is removed but the event 53 is preserved along with event 51. Panel 58 shows the noise that was removed by method 100, which is the difference between panel 52 and panel 56. Note that only the random noise components have been removed, the signal has been left unaltered even though part of the signal was included in the noise model. This is accomplished by careful selection in operation 15 of method 100, using narrow thresholds that differentiate between the amplitudes of the signal+noise dataset and the noise model.

A system 400 for performing the method 100 of FIG. 1 is schematically illustrated in FIG. 6. The system includes a data source/storage device 40 which may include, among others, a data storage device or computer memory. The data source/storage device 40 may contain recorded seismic data, synthetic seismic data, or signal or noise models. The data from data source/storage device 40 may be made available to a processor 42, such as a programmable general purpose computer. The processor 42 is configured to execute computer modules that implement method 100. These computer modules may include a transform module 44 for implementing a multi-scale, multi-directional transform to transform the seismic data into a domain in which it has sparse representation, a comparison module 45 for comparing the coefficients of different transformed seismic datasets, a selection module 46 for selecting desirable coefficients, and an inverse transform module 47 for performing an inverse transform of the desirable coefficients. The system may include interface components such as user interface 49. The user interface 49 may be used both to display data and processed data products and to allow the user to select among options for implementing aspects of the method. By way of example and not limitation, the noise-attenuated seismic data and removed noise computed on the processor 42 may be displayed on the user interface 49, stored on the data storage device or memory 40, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for attenuating noise in seismic data representative of a subsurface region of interest, the method comprising:
a. receiving, at a computer processor, a first seismic dataset representative of seismic signal and seismic noise and a second seismic dataset representative of seismic signal or seismic noise;
b. transforming, via the computer processor, the first seismic dataset into a domain wherein the first seismic dataset has a sparse or compressible representation to create a first set of representative coefficients;
c. transforming, via the computer processor, the second seismic dataset into a domain wherein the second seismic dataset has a sparse or compressible representation to create a second set of representative coefficients;
d. comparing, via the computer processor, the first set of representative coefficients to the second set of representative coefficients to identify desirable members of the first set of representative coefficients that are within a defined threshold of the second set of representative coefficients;
e. selecting, via the computer processor, the desirable members of the first set of representative coefficients to create an improved first set of representative coefficients; and
f. performing, via the computer processor, an inverse transform of the improved first set of representative coefficients to generate a modified seismic dataset.

2) The method of claim 1 wherein the domain is a curvelet domain.

3) The method of claim 1 wherein the domain is a wavelet domain.

4) The method of claim 1 wherein the desirable members of the first set of representative coefficients represent the signal in the first seismic dataset and wherein the modified seismic dataset is a noise-attenuated seismic dataset.

5) The method of claim 1 wherein the desirable members of the first set of representative coefficients represent the noise in the first seismic dataset and wherein the modified seismic dataset is a noise model.

6) The method of claim 5 further comprising subtracting the noise model from the first seismic dataset to generate a noise-attenuated seismic dataset.

7) The method of claim 1 further comprising receiving at least one more seismic dataset representative of seismic signal or seismic noise, transforming the at least one more seismic dataset into a domain wherein the at least one more seismic data have a sparse or compressible representation to create at least one more set of representative coefficients, and comparing the at least one more set of representative coefficients to the first set of representative coefficients.

8) A system for attenuating noise in seismic data representative of a subsurface region of interest, the system comprising:
a. a data source containing seismic data representative of the subsurface region of interest;
b. a computer processor configured to execute computer modules, the computer modules comprising:
i. a transformation module for transforming a first seismic dataset and a second seismic dataset into a domain wherein the first seismic dataset and the second seismic dataset have a sparse or compressible representation to create a first set of representative coefficients and a second set of representative coefficients;
ii. a comparison module for comparing the first set of representative coefficients and the second set of representative coefficients to determine desirable members of the first set of representative coefficients;
iii. a selection module for selecting the desirable members to create an improved first set of representative coefficients; and
iv. an inverse transformation module to transform the improved first set of representative coefficients into a modified seismic dataset; and
c. an user interface.

9) The system of claim 8 wherein the domain is a curvelet domain.

10) The system of claim 8 wherein the domain is a wavelet domain.

11) The system of claim 8 wherein the desirable members of the first set of representative coefficients represent the signal in the first seismic dataset and wherein the modified seismic dataset is a noise-attenuated seismic dataset.

12) The system of claim 8 wherein the desirable members of the first set of representative coefficients represent the noise in the first seismic dataset and wherein the modified seismic dataset is a noise model.

13) The system of claim 12 further comprising a subtraction module for subtracting the noise model from the first seismic dataset to generate a noise-attenuated seismic dataset.

14) An article of manufacture including a computer readable medium having computer readable code on it, the computer readable code being configured to implement a method for attenuating noise in seismic data representative of a subsurface region of interest, the method comprising:
a. receiving, at a computer processor, a first seismic dataset representative of seismic signal and seismic noise and a second seismic dataset representative of seismic signal or seismic noise;
b. transforming, via the computer processor, the first seismic dataset into a domain wherein the first seismic dataset has a sparse or compressible representation to create a first set of representative coefficients;
c. transforming, via the computer processor, the second seismic dataset into a domain wherein the second seismic dataset has a sparse or compressible representation to create a second set of representative coefficients;
d. comparing, via the computer processor, the first set of representative coefficients to the second set of representative coefficients to identify desirable members of the first set of representative coefficients that are within a defined threshold of the second set of representative coefficients;
e. selecting, via the computer processor, the desirable members of the first set of representative coefficients to create an improved first set of representative coefficients; and
f. performing, via the computer processor, an inverse transform of the improved first set of representative coefficients to generate a modified seismic dataset.

15) The article of manufacture of claim 14 wherein the desirable members of the second set of representative coefficients represent the signal in the first seismic dataset and wherein the modified seismic dataset is a noise-attenuated seismic dataset.

16) The article of manufacture of claim 14 wherein the desirable members of the second set of representative coefficients represent the noise in the first seismic dataset and wherein the modified seismic dataset is a noise model.

17) The article of manufacture of claim 16 further comprising subtracting the noise model from the first seismic dataset to generate a noise-attenuated seismic dataset.

18) The article of manufacture of claim 14 further comprising receiving at least one more seismic dataset representative of seismic signal or seismic noise, transforming the at least one more seismic dataset into a domain wherein the at least one more seismic data have a sparse or compressible representation to create at least one more set of representative coefficients, and comparing the at least one more set of representative coefficients to the first set of representative coefficients.
